(19) United States
(12) Patent Application Publication
(10) Pub. No.: US 2010/0025149 A1
(43) Pub. Date: Feb. 4, 2010

(54) Ladder With Stretcher

(76) Inventor: Ronald Harrison, Carlsbad, CA (US)

Correspondence Address: BIOTECH BEACH LAW GROUP , PC, 5677 OBERLINE DRIVE, SUITE 204, SAN DIEGO, CA, 92121, US

(21) Appl. No.: 12/505,440

(22) Filed: Jul. 17, 2009

Related U.S. Application Data
(60) Provisional application No. 61/137,397, filed on Jul. 30, 2008.

(51) Int. Cl. E06C 1/00; A61G 1/00; E06C 1/02; E06C 1/04; E06C 1/06

(52) U.S. Cl. 182/21; 5/626

(57) ABSTRACT

The ladder with stretcher including two elongated side members aligned generally parallel and connected to one another by a plurality of rungs, wherein at least one side member includes a storage cavity extending along a majority of a length of the side member, and a curtain that is reversibly stored within the storage cavity in a first configuration for use as a ladder and in a second configuration is joined to each of the two side members at opposing longitudinal ends to form a stretcher.

### CROSS-REFERENCE TO RELATED APPLICATIONS

This application claims priority to U.S. provisional patent application Ser. No. 61/137,397 entitled “LADDER WITH STRETCHER” filed on Jul. 30, 2008. which is incorporated herein by reference in its entirety.

### FIELD OF THE INVENTION

The present invention relates to the field of medical devices and more specifically to a ladder that converts to a stretcher, the ladder having at least one storage cavity along its side member for a selectively storing and removing a curtain to reversibly form the stretcher.

### BACKGROUND OF THE INVENTION

Dangerous environments often require the use of specialized equipment to better manage the risks inherent to such conditions. Unfortunately, these sorts of environments often place a premium on efficient travel, and as a result the advantages provided by any piece of equipment must be balanced against the difficulty of transporting it. For example, in situations such as providing assistance following a natural disaster, relief crews would often prefer to bring every piece of gear that might prove useful, however this preference is weighed against the need to travel quickly, often into areas where roads and rail lines have been disrupted. The modern battlefield presents similar complications, often forcing a compromise between speed and capability. In such environments, multi-function equipment can be invaluable, as it can reduce the weight and volume of gear that is needed for a given situation. Accordingly, there remains a need to develop improved devices that perform multiple functions and in particular to those that incorporate medical devices, such as for transportation of injured subjects.

### SUMMARY OF THE INVENTION

The present invention addresses needs to develop improved medical devices and provides related benefits. This is accomplished by providing a ladder that reversibly converts to a stretcher for use in medical emergencies. The interchanging between configurations is provided by reversibly storing a curtain within at least one of the side members that form the ladder. When the stretcher is needed the curtain is removed from the side member to form the base of the stretcher.

In one aspect of the present invention, the ladder with stretcher includes two elongated side members aligned generally parallel and connected to one another by a plurality of rungs, wherein each side member includes a storage cavity extending along a majority of its length; and a curtain including two reversibly joining halves, wherein each half is reversibly stored in a cavity as a first configuration for use as a ladder and in a second configuration each half is joined together to form a stretcher.

In another aspect of the present invention a ladder with stretcher is provided, which includes two elongated side members aligned generally parallel and connected to one another by a plurality of rungs, wherein at least one side member includes a storage cavity extending along a majority of a length of the side member; and a curtain, wherein the curtain is reversibly stored within the storage cavity as a first configuration for use as a ladder and in a second configuration is joined to each of the two side members along opposing longitudinal ends to form a stretcher.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 depicts the ladder with strectcher 10 in a stretcher configuration showing the transport of a patient 12. The elongated side members 14 are shaped to form carrying handles at opposing ends 15a, 15b.

FIG. 2A is a perspective view showing two elongated side members 14a, 14b aligned generally parallel and joined by a plurarlity of rungs 16. Extending along the inner length of each side member 14a, 14b is a storage cavity 18a, 18b. FIG. 2B is a cross-sectional view taken across line 2B of FIG. 2A showing the storage cavity 18a, 18b and its preferred positioning above the rung 16.

FIG. 3 depicts an exemplary closing structure 20a, provided with a zipper 22a, extending along the length of a side member 14a.

FIGS. 4A-B depict the transition of the ladder with stretcher 10 between the ladder configuration and stretcher configuration. FIG. 4A depicts unzipping a zipper 22a to expose one half of a curtain 24a. FIG. 4B depicts exposing the second half of the curtain 24b and joining the curtain halves 24a, 24b. Also shown are restraining straps 26a, 26b.

FIG. 5 is a partial view showing the stretcher configuration with both curtain halves 24a and 24b joined. Also shown is a joined restraining strap 26.

FIG. 6 depicts the linear engagement of two ladder devices 10 to form an extended ladder 100.

FIG. 7 is a partial view showing the engagement of opposing ends 15a, 15b using complementary engaging surfaces 28 and a securing strap 30 to form an extended ladder.

### DETAILED DESCRIPTION OF THE INVENTION

As an introduction to the invention, it is an object of the present invention to provide a device that eliminates or reduces the need to transport both a ladder and a stretcher to an emergency location. It is another object of the present invention to provide a device that allows the conversion of a ladder to a stretcher in an emergency situation to safely transport an injured subject. It is yet another object of the present invention to provide a combined ladder-stretcher that can be quickly and easily be interchanged between configurations. It is still another object of the present invention to provide a ladder-stretcher device having handles that can be grasped easily even when an injured subject is positioned on the stretcher. Additionally, it is an object of the present invention to provide a ladder-stretcher device that can be reversibly attached to another ladder-stretcher device such that the extended device can be used to assist climbing or bridging a variety of distances. Among those that will have particular use for the ladder with stretcher as described herein include, but are not limited to medical professionals and emergency responders, police, fire, military, survivalists and the like. Further objects of the present invention can be realized upon review of the various embodiments provided herein.

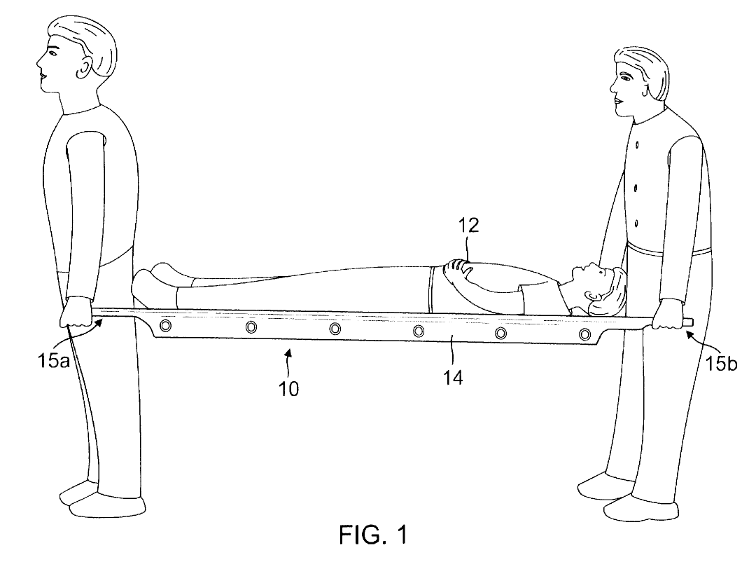

Now referring collectively to FIGS. 1-7, the present invention provides a device 10 that can be interchanged between a ladder and a stretcher. In one aspect of the present invention, the ladder with stretcher 10 includes two elongated side members 14a, 14b aligned generally parallel and connected to one another by a plurality of rungs 16. Preferably each side member 14a, 14b includes a storage cavity 18a, 18b extending along a majority of its length to house one half of a curtain 24a or 24b, which itself joins to an opposing half 24b or 24a to form a curtain 24 for use as a base of the stretcher. In the preferred embodiment, the curtain 24 includes two reversibly joining halves 24a, 24b, which may be stored in opposing cavities 18a, 18b of side members 14a, 14b. Thus, in a first configuration, the curtain 24 is stored within the cavity 18, which permits use of the device 10 as a ladder; and in a second configuration the curtain halves 24a, 24b join and extend between the elongated side members 14a, 14b to form a stretcher.

FIG. 1 depicts use of the ladder with stretcher device 10 in a stretcher configuration, which may be used to transport an individual 12 in need of medical attention. In preferred embodiments, opposing longitudinal ends 15a, 15b of the side members 14 are formed to provide handles to facilitate transport.

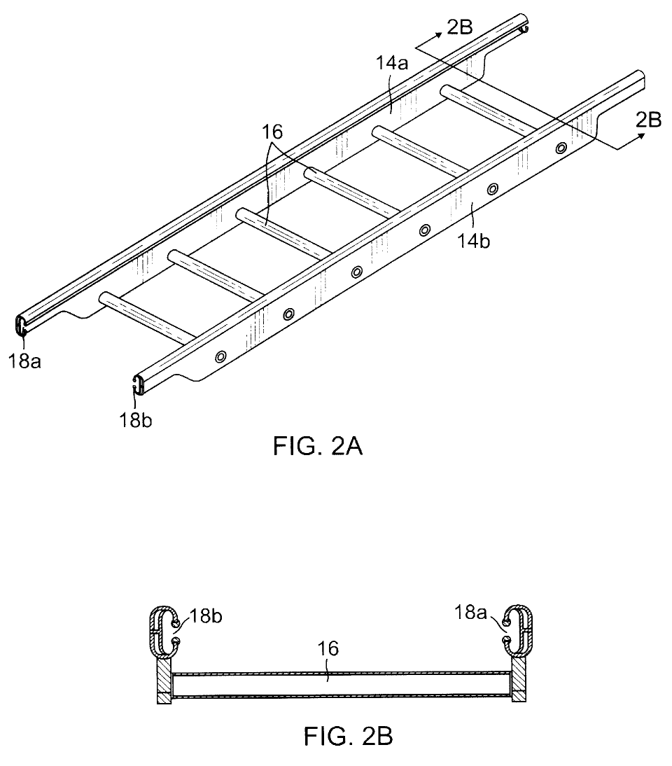

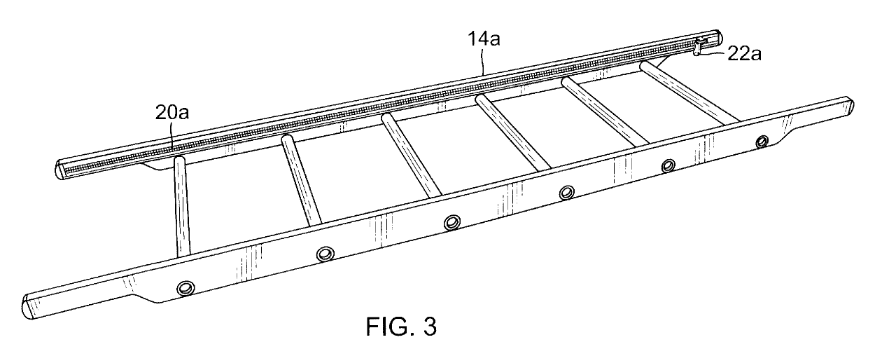

FIGS. 2A and 2B, show features of the elongated side members 14a, 14b joined by a plurality of rungs 16. Each side member 14a, 14b includes a storage cavity 18a, 18b, which extends the majority of the length of the side member 14a, 14b. Most preferably, the cavity 18a, 18b extends along the inner length each elongated member 14a, 14b. In this orientation the cavity 18 faces the rungs 16. However. in other embodiments cavities 18 extend along the outer lengths of side members 14, and thus face away from the rungs 16. Although the cavity 18 is not required to extend the entire length of the side member 14, such a configuration can be preferred for ease of manufacturing. Preferably the cavity 18 extends at least the longitudinal length of the curtain 24. Preferred cavities 18a, 18b are shown in more detail in FIG. 2B, which is a cross-sectional view (viewing along line 2B) of FIG. 2A. In the preferred embodiment, the cavities 18a, 18b are positioned vertically above the rung 16.

The cavities 18 may be provided in an open configuration, such as depicted in FIG. 2A or may include a closing structure 20 that reversibly closes along the cavity 18. An exemplary configuration is shown across one elongated member 14a in FIG. 3. As shown in FIG. 3, the closing structure 20a extends substantially the length of the elongated member 14a. Opening and closing of the closing structure 20a may be performed using a zipper 22a configuration as shown. Naturally, alternative configurations may be provided, such as those that include snaps, buttons, hooks, hook and loop (such as VELCRO) and the like.

In some embodiments, the cavity 18, can be used for storage of any number of components in addition to the curtain 24, such as, for example, first aid equipment, transfusion equipment, whole blood, plasma, or the like. In some embodiments, communications equipment such as for example, UHF/VHF radios, cellular telephones, walkie-talkies, or the like, can be stored within the cavity 18. The cavity 18 may include data ports for power or data transmission, batteries and the like. Further, certain embodiments can include, for example, heating elements, cooling elements, or the like, within the cavity 18, which may be separate from or integrated with the curtain 24.

The side members 14, and rungs 16 can be formed from any suitable material known in the ladder or construction arts. Such materials include, but are not limited to metal, metal alloy, steel, aluminum, ceramics, plastics including thermoplastics or thermosets, wood, composites and the like.

In certain embodiments, the device 10 can be coated, at least in part, with a material to change its, for example, optical signature, infrared signature, radar signature, reflectivity, surface hardness, or the like. Such characteristics can be increased, such as to signal help or may be decreased, such as when detection is undesirable. The device 10 can be coated with rubber, or painted, or powder coated, or the like. In some embodiments, the side members 14 or rungs 16 can be coated with a non-slip material.

Preferably the side member 14 is constructed from a metal alloy and most preferably aluminum. The side member 14 and cavity 18 can be formed by methods known to those skilled in the mechanical arts. Such methods include the use of presses, rollers and the like for rolling, pressing, forming and bending of materials. Preferably the side member 14 is formed to include the cavity 18; however, the side member 14 can be bored or cut to form the cavity 18.

In certain embodiments, the side members 14 can include attachment points for mechanically connecting the ladder-stretcher 10 to, for example, a vehicle, a frame, or the like. In embodiments that include attachment points for connecting the ladder-stretcher 10 to a frame, the frame can be designed to allow for the “stacking” of ladder-stretchers 10, both occupied and unoccupied, such as in an ambulance or aircraft.

As shown in FIG. 1, preferably the elongated side members 14 have opposing ends 15a, 15b, which are formed to provide elevated handles. Elevation permits the ends to be more easily grasped, especially when an injured subject 12 is positioned on the stretcher. This elevation also provides a “set-off” space when the stretcher is placed on the ground or atop a vehicle, which removes the individual 12 from physical contact with the ground or vehicle, providing a cleaner, more comfortable conveyance, as this prevents the individual from physically contacting uncomfortable or potentially contaminating substances such as cement, soil, water, or mud.

A plurality of rungs 16 extend perpendicularly between and join the two side members 14 (14a, 14b), thereby forming a ladder. The rungs 16 can be hollow, solid, a combination thereof, or the like. Preferably the rungs 16 are constructed from a metal alloy and most preferably aluminum. The rungs can be formed by methods known to those skilled in the mechanical arts. The number of rungs is nonlimiting but preferably includes at least 3, more preferably 5 and even more preferably 6. The number of rungs can vary depending on the intended height of the ladder and the desired spacing between rungs. Naturally the shape is also non-liming and may be round, semi-cylindrical and the like.

The lengths of the rungs 16 can vary but are preferably the same or about the same. The lengths of the rungs 16 will determine, at least in part, the width of the stretcher. Though the lengths of the rungs 16 are nonlimiting, in the preferred embodiment the lengths are between about fifteen inches to about thirty inches, more preferably about seventeen inches to about twenty five inches and most preferably about nineteen inches to about twenty-two inches. Again, variations outside of these ranges are also encompassed by the present invention. Long rungs 16 can be desired when an injured subject is equipped with military or survival equipment. As can be viewed in the cross-sectional view in FIG. 2B, in the preferred embodiment the plurality of rungs 16 are positioned vertically below the storage cavity 18a, 18b. Positioning the rungs 16 below the storage cavity 18a, 18b may facilitate access to the cavity and may allow the rungs 16 to provide additional support during transport of an injured individual (as can be seen in FIG. 1).

Preferably the curtain 24 is provided as two halves 24a, 24b that can be joined to form a single curtain 24 and disjoined for storage in opposing storage cavities 18a, 18b. The halves 24a, 24b can be designed for joining in any suitable fashion. For example, the halves 24a, 24b can join equidistant from the elongated side members 14a, 14b or on an angle relative to the side members 14a, 14b. In certain embodiments the curtain 24 can be joined such that the joining means is not directly below the subject 12. The curtain 24 can be formed cut, shaped and sewn from suitable materials known to those in the medical arts including cotton, canvas, polyester and the like. The curtain 24 can be provided in a solid or whole configuration or can be provide in a mesh configuration, or a combination thereof. The curtain 24 can be flame retardant, tear resistant and the like. The curtain halves 24a, 24b can be joined using any suitable technique such as incorporating zippers, hook and loop (VELCRO), snaps, buttons, fasteners and the like. Joining should be reversible. The opposing end of each curtain half 24a, 24b is attached to a side member 14a, 14b, preferably along the length of the curtain 24. Attachment can occur along an inner surface within the cavity 18. Attachment can include permanent attachment or reversible attachment: however, attachment should be sufficiently secure to prevent unwanted detachment. Attachment can be via zipper, button, snaps, fastener, tongue and groove, hook and loop (VELCRO) and the like. In one embodiment a loop is sewn along the end of the curtain 24, a rod is inserted through the loop and engaged into a complementary surface positioned within the storage cavity.

Storing the curtain halves 24a, 24b in the cavities 18a, 18b can include rolling each curtain half 24a, 24b and placing it in the corresponding cavity 18a, 18b, or the device 10 can include a retractable curtain 24. In a retractable configuration gearing such as those used in window blinds is adapted for use with the present invention. Retracting the curtain 24 can entail a tug to activate the gearing then release to permit the winding of the curtain 24. Alternatively, the curtain 24 can be physically inserted into the cavity 18. The cavity can then optionally close such as by zipping a closing structure 20 or attaching a cover, such as a cover with complementary hook and loop (VELLCRO). An exemplary embodiment of the invention utilizing a zipper closing structure 20a is shown in FIG. 3. Zipper 22a secures the curtain half 24a within the cavity 18a of the elongated side member 14a.

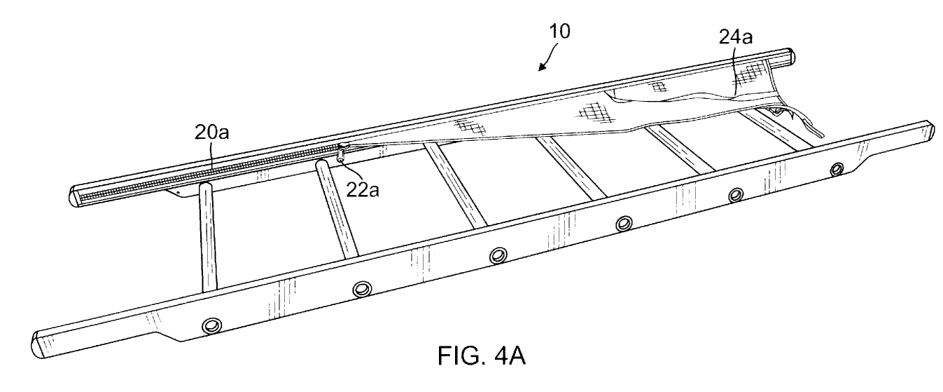

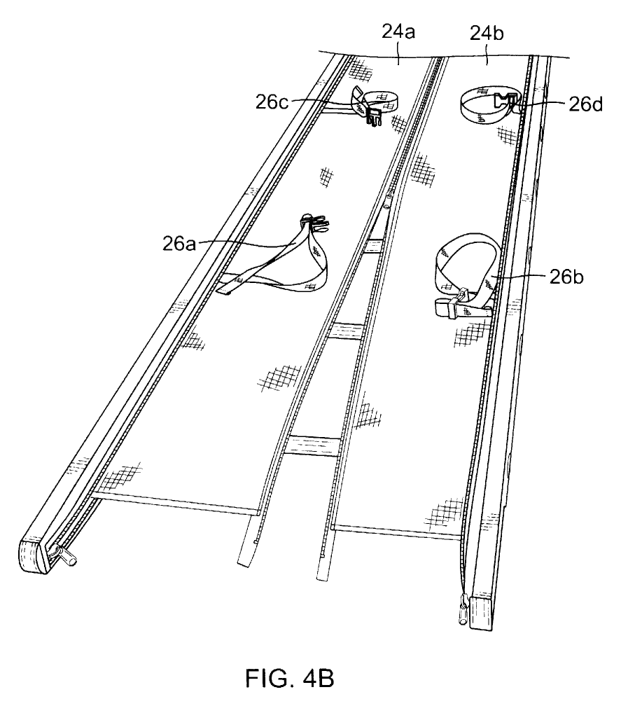

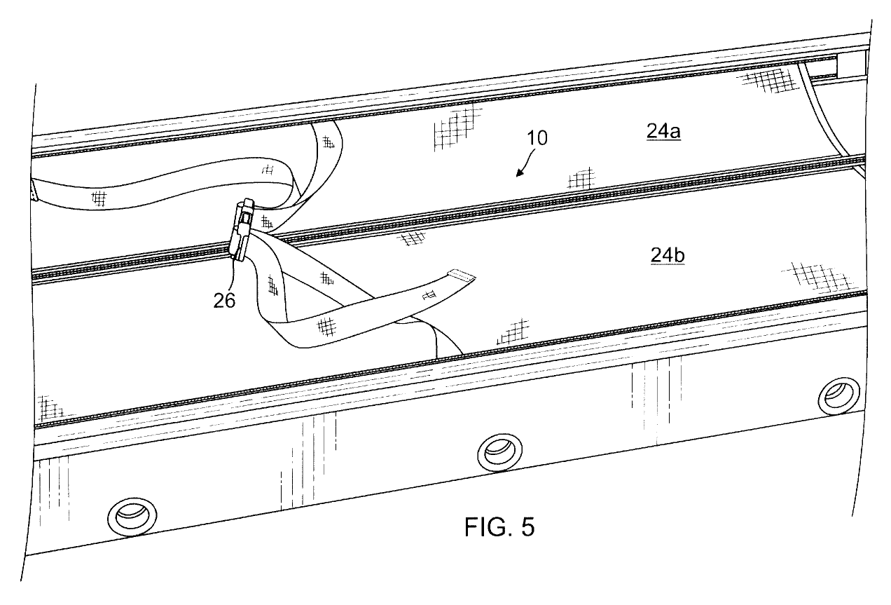

FIGS. 4A-B depict an exemplary transition of the device 10 between the ladder configuration and stretcher configuration. In FIG. 4A zipper 22a opens the closing structure 20a to expose one half of the curtain 24a. FIG. 4B depicts joining the curtain halves 24a, 24b to form the curtain 24. Also viewable are the restraining strap halves 26a, 26b, 26c, 26d. Naturally, the restraining halves 26a, 26b, 26c, 26d, are sized to accommodate a variety of patient sizes, which may include consideration of any personal or first aid equipment in use about the patient, such as, for example, a flak jacket or a wound dressing. FIG. 5 shows a partial view demonstrating fully joined curtain halves 24a, 24b and a secured restraining strap 26.

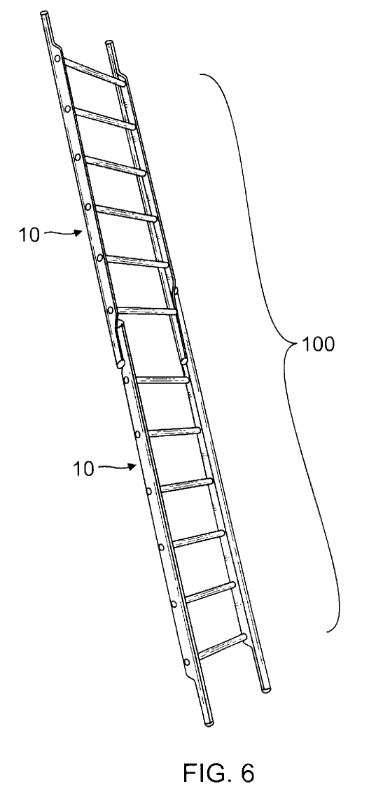

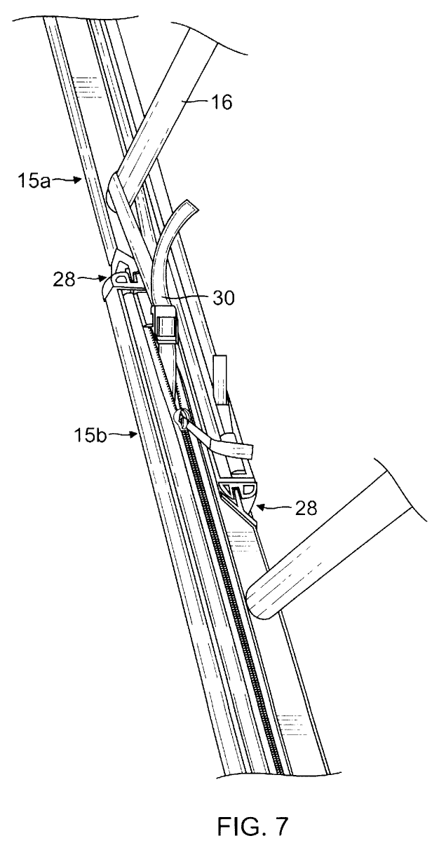

Another preferred configuration is provided in FIGS. 6 and 7. In FIG. 6, two ladders 10, of the present invention can be attached to form an extended ladder 100. Attachment may be by any suitable means, which may be further considered in view of prior ladder configurations.

An exemplary means for attaching devices 10 and thus form an extended ladder 100 is shown in FIG. 7. In FIG. 7 complementary engagement structures 28 are positioned at opposing ends 15a, 15b of side members 14. Engagement facilitates proper alignment and provides support. In addition, a securing strap 30, which is attached to one member end 15b may be secured to the rung 16 nearby the second member opposing end 15a to further strengthen attachment. This locks the ladders together. In alternative configurations the devices 10 may be joined using an engagement means 28 that incorporates a lock, a pin, a swivel, springs and the like to reversibly interlock devices 10. Release of the ends 15a, 15b can include release of the locking means and tightening strap 30.

In another embodiment, at least two devices 10 are attached to form an extended ladder 100 by inserting the ends 15a, 15b of side members 14 in a sleeve, such as an aluminum sleeve. In alternative embodiments, ladders 10 including locking surfaces to permit joining to form an extended ladder 100.

Although preferred embodiments have been described, variations to the preferred embodiments are also encompassed by the present invention. In some variations of the present invention, the curtain is a single sheet, which is stored in only one of the elongated side members. In this configuration the curtain is attached to one side member and reversibly attaches to the second side member, such as by zipper, hook and loop, snaps and the like. Thus in this embodiment only one storage cavity is required.

In another embodiment, the cavity extends along the outer length of the side member. In this configuration, the curtain wraps over the side member to form a stretcher. In some embodiments, the curtain may be removed entirely from the side members such as to interchange curtains or facilitate cleaning.

In other embodiments, the opposing ends of the side members include contours for easier grip.

Having described the invention in detail, it will be apparent that modifications, variations, and equivalent embodiments are possible without departing from the scope of the invention defined in the appended claims. Furthermore, it should be appreciated that all examples in the present disclosure are provided as non-limiting examples.

What is claimed is:

1. A ladder with stretcher comprising:
two elongated side members aligned generally parallel and connected to one another by a plurality of rungs, wherein at least one side member comprises a storage cavity extending along a majority of a length of the side member; and
a curtain, wherein the curtain is reversibly stored within the storage cavity in a first configuration for use as a ladder and in a second configuration is joined to each of the two side members at opposing longitudinal ends to form a stretcher.

2. The ladder with stretcher according to claim 1, wherein the plurality of rungs are positioned vertically beneath the cavity.

3. The ladder with stretcher according to claim 1, wherein storage cavity extends along an inner length of the side member.

4. The ladder with stretcher according to claim 1, further comprising a closing structure that extends along the cavity to reversibly close the cavity when the curtain is stored.

5. The ladder with stretcher according to claim 1, wherein the two elongated side members further comprise engaging structures to engage a second ladder, wherein engagement results in two ladders substantially linear in orientation.

6. A ladder with stretcher comprising:
two elongated side members aligned generally parallel and connected to one another by a plurality of rungs, wherein each side member comprises a storage cavity extending along a majority of its length; and
a curtain comprising two reversibly joining halves, wherein each half is reversibly stored in a different cavity in a first configuration for use as a ladder and in a second configuration each half is joined together at one end and at the opposing end to the side member.

7. The ladder with stretcher according to claim 6, wherein the plurality of rungs are positioned vertically beneath the cavities.

8. The ladder with stretcher according to claim 6, wherein each storage cavity extends along an inner length of the side member.

9. The ladder with stretcher according to claim 6, further comprising a closing structure for each cavity, wherein the closing structure extends along the cavity to reversibly close each cavity when the curtain is stored.

10. The ladder with stretcher according to claim 6, wherein the two elongated side members further comprise engaging structures to engage a second ladder, wherein engagement results in two ladders substantially linear in orientation.

11. The ladder with stretcher according to claim 6, further comprising restraining straps to restrain a subject on the stretcher.
